(19) United States
(12) Patent Application Publication
(10) Pub. No.: US 2015/0356229 A1
(43) Pub. Date: Dec. 10, 2015

(54) PHYSICAL CELL ELECTROMIGRATION DATA GENERATION

(71) Applicant: QUALCOMM Incorporated, San Diego, CA (US)

(72) Inventors: Wai Kit Siu, San Diego, CA (US); Paul Ivan Penzes, Irvine, CA (US)

(21) Appl. No.: 14/300,000

(22) Filed: Jun. 9, 2014

(51) Int. Cl. G06F 17/50

(52) U.S. Cl. CPC G06F 17/5081

(57) ABSTRACT

Systems and methods for efficiently generating electromigration reliability data for physical cells in an integrated circuit cell library are disclosed. Data for tables of electromigration susceptibility can be iteratively generated for multiple capacitive loadings on a cell output and for multiple transition times of a cell input. Each iteration can include simulating electrical performance of the physical cell and identifying a region with the largest ratio of current density to electromigration reliability limit. Between iterations, the data period of the input signal is updated using the ratio of current density to electromigration reliability limit and a relationship between currents and data period. Iterations may end when the ratio is close to one. The result can be used to evaluate electromigration reliability of an integrated circuit design and modify the design accordingly.

### FIELD

This disclosure relates to integrated circuits and, more particularly, to generating electromigration reliability data for physical cells in an integrated circuit library.

### BACKGROUND

As integrated circuits have continued to grow more complex and integrated circuit process technology has advanced, the importance of electromigration (the gradual drift of atoms in a conductor caused by currents) to reliability has also increased. Prior design methodologies have used simplifications and approximations to evaluate electromigration reliability. In particular, prior methods have not used electromigration reliability data for the individual physical cells used in the design. These methodologies are inadequate for advanced technologies. Generation of electromigration reliability data for the many physical cells in an integrated circuit library may take so long (e.g., months of computer time) using previous methods, that generation of the data was not practical.

### SUMMARY

In one aspect, a method is provided for use in generating electromigration reliability data for a physical cell in an integrated circuit cell library. The method includes: iteratively evaluating electromigration susceptibility for the physical cell for an input transition time for an input signal of the physical cell and a capacitive loading on an output of the physical cell, wherein each iteration includes simulating electrical performance of the physical cell using the input transition time, the capacitive loading, and a data period of the input signal, and identifying the electromigration susceptibility of the physical cell for the input transition time and the capacitive loading based on current densities from the simulated electrical performance; determining, after each iteration, whether to perform a further iteration using a comparison of the identified electromigration susceptibility and an evaluation limit; determining, when it is determined to perform a further iteration, the data period for the further iteration using a relationship between the data period and currents in the physical cell; and storing, when it is determined to not perform a further iteration, the data period of the last iteration.

In another aspect, a method is provided for use in designing an integrated circuit. The method includes: evaluating a plurality of cells instantiated in an integrated circuit design to determine whether each of the plurality of cells is susceptible to electromigration: the evaluating including: determining an output capacitance on an output of each of the plurality of cells; determining an input transition time on an input of each of the plurality of cells; determining, for each of the plurality of cells, a maximum toggle rate using the input transition time and output capacitance for that cell; and comparing the maximum toggle rate for each of the plurality of cells to a desired operating frequency for that cell.

In another aspect, a method is provided for use in designing an integrated circuit using an integrated circuit cell library. The method includes: generating electromigration reliability data for each of a plurality of physical cells in the integrated circuit cell library; and evaluating electromigration reliability of an integrated circuit design using the generated electromigration reliability data, wherein generating electromigration reliability data includes generating electromigration reliability data for each of the plurality of physical cells includes generating electromigration reliability data for a plurality of capacitive loadings for each of a plurality of input transition times, wherein for each of the plurality of physical cells, each of the plurality of capacitive loadings, and each of the plurality of input transition times generating the electromigration reliability data includes: iteratively evaluating electromigration susceptibility for the physical cell for the input transition time for an input signal of the physical cell and the capacitive loading on an output of the physical cell, wherein each iteration includes simulating electrical performance of the physical cell using the input transition time, the capacitive loading, and a data period of the input signal, and identifying the electromigration susceptibility of the physical cell for the input transition time and the capacitive loading based on current densities from the simulated electrical performance; determining, after each iteration, whether to perform a further iteration using a comparison of the identified electromigration susceptibility and an iteration limit; determining, when it is determined to perform a further iteration, the data period for the further iteration using a relationship between the data period and currents in the physical cell; and storing, when it is determined to not perform a further iteration, the data period of the last iteration in the electromigration reliability data.

In another aspect, a non-transitory computer readable medium is provided. The non-transitory computer readable medium includes instructions that, when executed by a processor, cause the processor to perform operations for use in generating electromigration reliability data for a physical cell in an integrated circuit cell library. The instructions include instructions that cause the processor to: iteratively evaluate electromigration susceptibility sensitivity for the physical cell for an input transition time for an input signal of the physical cell and a capacitive loading on an output of the physical cell, wherein each iteration includes simulating electrical performance of the physical cell using the input transition time, the capacitive loading, and a data period of transitions on the input signal, and identifying the electromigration susceptibility sensitivity of the physical cell for the input transition time and the capacitive loading based on current densities from the simulated electrical performance; determine, after each iteration, whether to perform a further iteration using a comparison of the identified electromigration susceptibility sensitivity and an evaluation electromigration limit; determine, when it is determined to perform a further iteration, the data period for the further iteration using the ratio of the identified electromigration sensitivity to the electromigration limit and a relationship between the data period and currents in the physical cell; and store, when it is determined to not perform a further iteration, the data period of the last iteration.

Other features and advantages of the present invention should be apparent from the following description which illustrates, by way of example, aspects of the invention.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a flowchart of a process for generating electromigration reliability data for physical cells in an integrated circuit library according to a presently disclosed embodiment;

FIG. 2 is a schematic diagram illustrating aspects of the process of FIG. 1;

FIG. 3 is a flowchart of a process for creating an integrated circuit according to a presently disclosed embodiment;

FIG. 4 is a block diagram of an integrated circuit according to a presently disclosed embodiment; and

FIG. 5 is a block diagram of a system for generating electromigration reliability data for a library of physical cells according to a presently disclosed embodiment.

### DETAILED DESCRIPTION

The detailed description set forth below, in connection with the accompanying drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in simplified form in order to avoid obscuring such concepts.

Electromigration reliability data for cells in an integrated circuit cell library can be used to evaluate the susceptibility to electromigration of an integrated circuit design using the library. The integrated circuit cell library includes physical cells that each have an associated layout and function. The electromigration susceptibility of the cell can depend on the capacitive loading on an output of the cell, the transition time (slew rate) of an input of the cell, and the toggle rate (frequency) of the input. Increased capacitive loading on the output of the cell will increase the current used to drive the output and thereby increase current densities in areas of the cell. Increased transition time of the input of the cell may decrease current densities, for example, resulting in lower peak currents due to slower output transitions. Increased toggle rate of the input will increase the current densities since transitions occur more frequently. The electromigration reliability data for the cells may be in the form of tables with each table entry being a maximum toggle frequency for a particular combination of output capacitive loading and input transition time.

The maximum toggle frequency is the toggle frequency that the cell can be operated at without exceeding electromigration reliability limits. If the current densities in an integrated circuit do not exceed the electromigration reliability limits, the integrated circuit should be reliable with respect to failures caused by electromigration. The electromigration reliability limits are maximum current densities that provide a desired integrated circuit lifetime. As current densities increase beyond the electromigration reliability limits, the likelihood of failures due to electromigration increases. Electromigration can cause circuit failures, for example, due to voids in a interconnect line that prevent signals from flowing between elements.

The maximum toggle frequencies in the table are for a particular physical cell, output capacitance, and input transition time (e.g., a rise time for an input signal to transition from a low level to a high level and a fall time for the input signal to transition from the high level to the low level). A table may also pertain to other particular conditions for example an operating temperature, an operating voltage, and fabrication process conditions. Three different tables can be created for each physical cell: a table for average current, a table for root-mean-square (RMS) current, and a table for peak current. Table 1 is an example of an electromigration reliability data table.

TABLE 1

| | Output Capacitance | | | |
|---|---|---|---|---|
| Input | max. freq. | max. freq. | . . . | max. freq. |
| Transition | max. freq. | | | |
| Time | . | | | |
| | . | | | |
| | . | | | |
| | max. freq. | | | max. freq. |

Using these tables, integrated circuit designers can verify that a design will be reliable with respect to electromigration by verifying that each physical cell placed in the design complies with its respective electromigration reliability limit. When the tables are used, maximum toggle frequencies for output capacitances and input transition times not included in the table may be determined, for example, by interpolation or extrapolation.

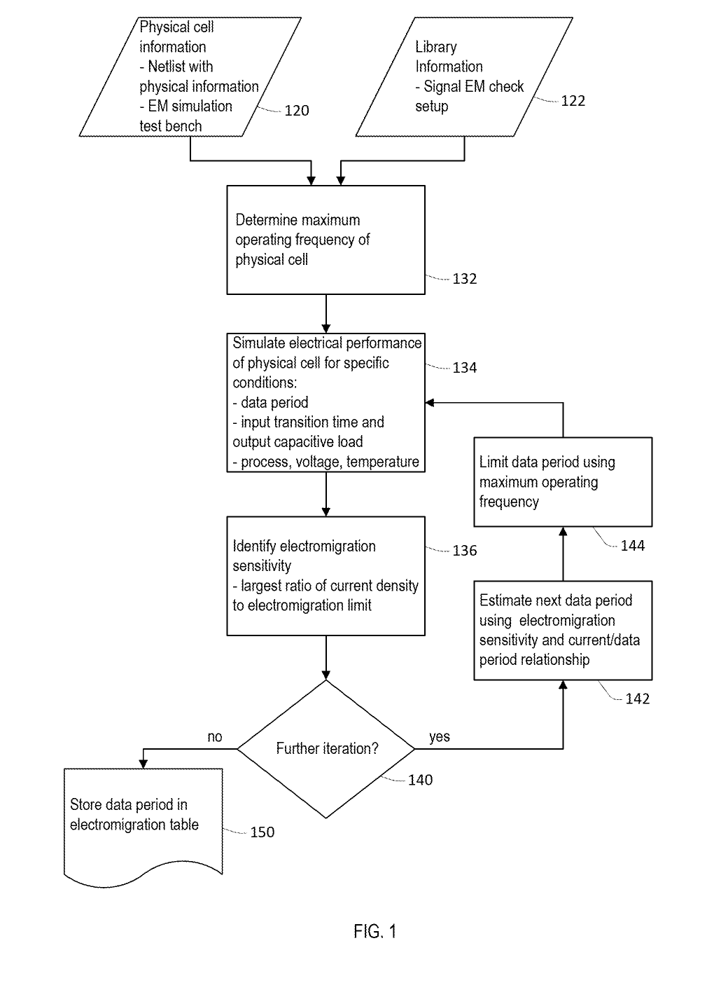

FIG. 1 is a flowchart of a process for generating electromigration reliability data for physical cells in an integrated circuit library according to a presently disclosed embodiment. The process can be used to efficiently (e.g., hours of computer time) create electromigration reliability data tables for a library of physical cells. The illustrated process can be performed for each of the maximum frequency entries (each table entry being for a particular input transition time and a particular output capacitance) in the electromigration reliability table for a physical cell. That is, the process is repeated for each of multiple output capacitances for each of multiple input transition times. The process may be performed, for example, by a computer executing program instructions.

In block 120, one or more input files containing information about the physical cell being analyzed are provided. The process may, for example, read the information about the physical cell from a computer database. The information about the cell includes a netlist that includes physical information such as sizes of each transistor in the cell, wire widths and integrated circuit layers used to interconnect elements of the cell. The netlist may be extracted from a layout of the physical cell. The input files also include information about how to simulate (e.g., stimulus waveforms) the cell for electromigration effects.

In block 122, one or more input files containing information about the design library used are provided. The process may, for example, read the information about the design library from a computer database. The information about the library includes electromigration reliability limits (e.g., maximum current densities for various integrated circuit layers). The information can also include simulation libraries (e.g., transistor models).

In step 132, a minimum data period (or maximum operating frequency) at which the cell under test performs its intended function is determined for the output capacitance and input transition time being tested. Note that descriptions using the term period can generally be substituted for descriptions using the term frequency, and vice versa, using on the reciprocal relationship between period and frequency. The maximum operating frequency may be determined as the maximum frequency of a signal input to the cell under test for which a resulting output signal of the cell under test has a full voltage swing. The full voltage swing may be defined, for example, as percentage (e.g., 80%, 90%, or 95%) of the supply voltage used by the cell under test or the supply voltage less an offset (e.g., the supply voltage—100 mV). A circuit simulator, for example, HSPICE, may be used to determine the maximum operating frequency. The minimum data period may also be limited by the input transition time (e.g., the minimum data period may be limited to be greater than or equal to twice the input transition time).

In step 134, a simulation is performed for analysis of the electromigration effects on the physical cell. The simulation is performed at the particular input transition time and output capacitance being analyzed. Step 134 may use a circuit simulator such as HSPICE or Totem. The simulation is performed using a particular process condition, voltage supply, and temperature. The simulation provides a simulated electrical performance (e.g., voltages and currents versus time) of the physical cell.

The simulation of step 134 is performed for a data period of the input signal. The data period is a repetition time of the simulated operation of the cell. The simulation is first performed for an initial data period. The initial data period may be set to a value large enough that all current densities in the cell resulting from the input signal are expected to be below the electromigration reliability limits. Alternatively, the initial data period may be set to the minimum data period determined in step 132. Alternatively, a prior result data period from other capacitive loads or input transition times or for another physical cell may be used. The value used for the initial data period is not critical to the process but may affect the number of iterations performed. The term data period is used inclusively and may be used with signals that may not commonly be termed data. For example, when the physical cell is a clock buffer, the data period can be the period of an input clock signal to the clock buffer.

In step 136, the process identifies an electromigration susceptibility of the physical cell for the data period, the input transition time, and the capacitive loading. The electromigration susceptibility is based on current densities from the electrical performance simulation of step 134. The simulation of step 134 produces currents from which the current densities can be determined using the input files containing information about the physical cell (block 120). Current densities are generally expressed as current per area (e.g., units of A/m²). Current densities may also be expressed current per line width (e.g., units of mA/μm). Per-width current density can be converted to per-area current density by scaling by the thickness of the relevant integrated circuit layer.

The process identifies the electromigration susceptibility of the physical cell as a most susceptible electromigration region (location and integrated circuit layer) in the physical cell. The most susceptible region may be found by determining for each region in the physical cell the ratio of current density to a corresponding electromigration reliability limit and identifying the largest of the ratios. The ratio of the current density to the electromigration reliability limit may be expressed as a percentage. The electromigration reliability limit can be selected based on the current density that will provide a desired immunity to electromigration for integrated circuits developed using the cell library. The electromigration reliability limit may also be termed the maximum current density. The electromigration reliability limit can be different for different materials (e.g., for different metal layers) used in the physical cell.

The process may identify the electromigration susceptibility using average current densities, RMS current densities, or peak current densities. The average, RMS, and peak current densities are calculated over the data period. The peak current density may be identified ignoring the direction of the current. The average current density may also be an average of absolute values of current density or the absolute value of the average current density. Other measures of current density may also be used. The electromigration reliability limit may differ for the different measures of current density; for example, the electromigration reliability limit for peak current densities may be greater than the electromigration reliability limit for average current densities.

Step 134 and step 136 are iteratively performed to evaluate electromigration susceptibility. In step 140, the process determines whether to perform a further iteration. If a further iteration is to be performed, the process continues to step 142; otherwise, the process continues to step 150.

The process can determine whether to perform a further iteration based on a comparison of the identified electromigration susceptibility and an evaluation limit. For example, the process can compare the largest ratio of current density to electromigration reliability limit for the cell to the evaluation limit. The evaluation limit may be a range and may be set by a user. The evaluation limit may be set, for example, so that iterations end when the ratio is between 95% and 100%. Using 100% (rather than, for example, 105%) as the maximum value of the evaluation limit avoids determining a toggle frequency that would violate the electromigration reliability limit. The minimum value of the evaluation limit can be chosen as a trade-off between the number of iterations performed and the accuracy of the determined maximum toggle frequency. The minimum value of the evaluation limit may be termed an electromigration accuracy level. The process may include additional conditions for ending iterations. Example additional conditions include a maximum number of iterations and a minimum change in the data period between iterations.

In step 142, the process estimates or determines a data period to be used for a next iteration of step 134. The next data period is determined using a relationship between the data period and currents in the physical cell. When electromigration susceptibility exceeds the evaluation limit, the data period is increased to lower currents and when the electromigration susceptibility is less than the evaluation limit, the data period is decreased to increase currents. The relationship between the data period and currents in the physical cell is used so that the next data period results in currents that closer to electromigration reliability limit. This allows the process to quickly converge on the maximum frequency (minimum data period) value for the electromigration reliability data table. If the electromigration susceptibility is 110%, for example, and the relationship between the data period and current is linear, the data period for the next iteration can be decreased by 10% so that on the next iteration the electromigration susceptibility will be close to 100%.

The next data period can be estimated using the ratio of the largest current density to the electromigration reliability limit and a relationship between the data period and currents in the physical cell. The relationship may be an approximation. The process can use the following relationships between the data period and currents:

$$for average current \text{:} {I}_{d c} ≅ α {fV}_{DD} {C}_{L} ;$$

$$for RMS current \text{:} {I}_{rm s} ≅ 1.26 \sqrt{\frac{α f}{{t}_{r }}} {V}_{DD} {C}_{L} ; and$$

$$for peak current \text{:} {I}_{peak} ≅ 1.10 \sqrt{\frac{α f}{{t}_{r}}} {V}_{DD} {C}_{L} ,$$

where αf is an effective frequency, V_{DD} is the supply voltage, C_{L} is the capacitive load, and tᵣ is the input transition time. Since the electromigration susceptibility is proportional to the current, these relationships between the data period and currents also provide the relationship between data period and electromigration susceptibility.

Accordingly, the process can determine the next data period using the following:
for average current: Tₙₑₓₜ [symbol] T_{current}×ratio;
for RMS current: Tₙₑₓₜ [symbol] T_{current}×ratio²; and
for peak current: Tₙₑₓₜ [symbol] T_{current}×ratio,
   where Tₙₑₓₜ is the next data period, T_{current} is the current data period, ratio is electromigration susceptibility expressed as the largest ratio of current density to electromigration reliability limit. Other relationships between the data period and the electromigration susceptibility can also be used.

In step 144, the next data period determined in step 142 is checked to see if it would violate the minimum data period determined in step 132. If the minimum data period would be violated, the next data period is set to the minimum data period. Step 144 limits the data period for the next iteration to a period longer or equal to the minimum data period. The process then returns to step 134 to simulate the cell using the next data period. Bounding the data period in step 144 avoids performing an iteration with a data period for which the cell under test does not function properly which would result in erroneous electromigration susceptibility results. The combination of estimating the next data period using a relationship between current and data period in step 142 and bounding the data period to a minimum data period in step 142 allows the process to converge on the maximum frequency for the electromigration reliability data table in only a few iterations.

In step 150, the data period used for the last iteration is stored, for example, in an entry in the electromigration reliability table for the physical cell under test. The data in stored in the table entry that corresponds to the output capacitance and input transition time being evaluated. A toggle rate in the table may be set to, for example, the reciprocal of the data period. Alternatively, the toggle rate may be the reciprocal of the data period divided by two. The factor of two may be used when the toggle rate is defined to count both rising and falling transitions, which each occur in one period. The value saved in the table may also be scaled for units, for example, when the time period is in nanoseconds and the frequency is in hertz, the value may be scaled by 1E9.

The process illustrated in FIG. 1 is subject to many variations, including adding, omitting, reordering, or altering steps. Additionally, steps may be performed concurrently. The information used or produced by some steps of the process may be shared for different measures of electromigration susceptibility, different input transition times, different output capacitances, and different physical cells. For example, the information from step 120 and step 122 for one physical cell may be used in the other steps for multiple input transition times and output capacitances.

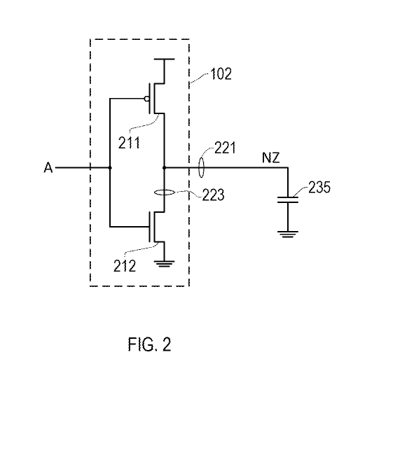

FIG. 2 is a schematic diagram illustrating aspects of the process of FIG. 1. FIG. 2 shows an inverter cell with an input A and an output NZ. The inverter includes a p-channel transistor 211 having its gate connected the input A, its source connected to a voltage supply, and it drain connected to the output NZ. The inverter also includes an re-channel transistor 212 having its gate connected to the input A, its source connected to a ground reference, and its drain connected to the output NZ. The inverter is simulated (step 134) with an output capacitance 235 connected to the output NZ and with a particular input transition time and data period for the input signal A. Identifying electromigration susceptibility of the inverter (step 136) includes evaluating current density to the output NZ (221). The electromigration susceptibility also includes evaluating current densities internal to the cell, for example, the current density on the signal path between the output NZ and the n-channel transistor (223). Other physical cells may be more complex and include more elements than the inverter illustrated in FIG. 1; however, the process for generating electromigration reliability data can be performed in a like manner.

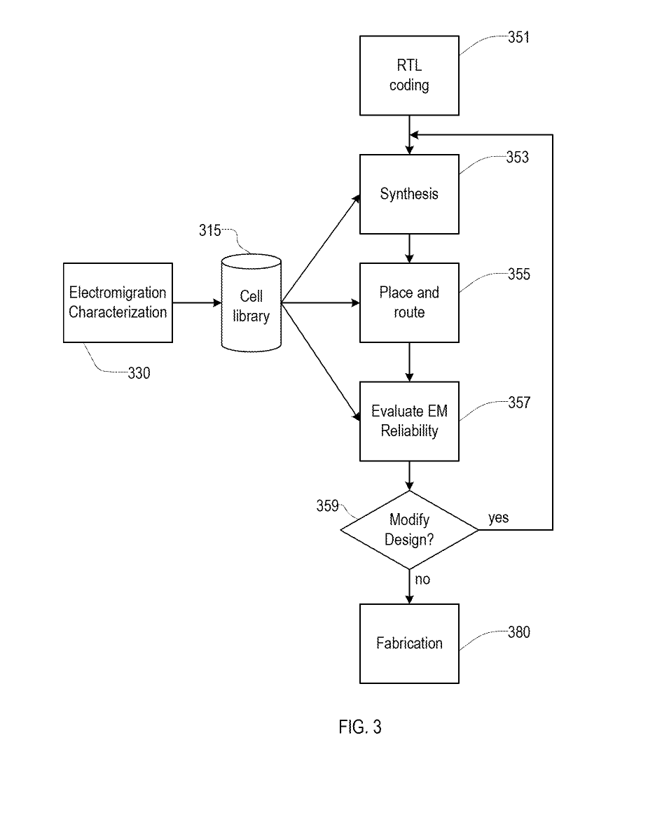

FIG. 3 is a flowchart of a process for creating an integrated circuit according to a presently disclosed embodiment. The process includes a register-transfer level (RTL) coding step 351, where an RTL description of a design is coded. The coding may use, for example, the Verilog hardware description language. The RTL description describes operation of the integrated circuit. The RTL description may additionally specify timing characteristics, for example, frequencies of clock signals. In a synthesis step 353, the process converts the RTL description to a netlist including cells selected from a cell library 315.

The cell library 315 includes electromigration reliability data created in an electromigration characterization step 330. The process of FIG. 1 may be used to perform the electromigration characterization step 330. The electromigration characterization step 330 may, in an embodiment, include reading information from the cell library 315, for example, information about physical cells being analyzed and information about design libraries.

In a place and route step 355, the process converts the netlist from the synthesis step 353 to a physical layout of the integrated circuit. The process uses physical information from the cell library 315 to produce the physical layout. In overview, the process determines a placement for each cell in the netlist and instantiates an instance of the cell at the determined placement. The process also routes connections between the instantiated cells. In some embodiments, the process may iterate the synthesis step 353 and the place and route step 355, for example, to improve or optimize the integrated circuit.

In an electromigration reliability evaluation step 357, the process evaluates the integrated circuit design for susceptibility to electromigration. The evaluation uses the electromigration reliability data, created in the electromigration characterization step 330, from the cell library 315. The process evaluates each instantiated cell to determine whether the cell is susceptible to electromigration. The process determines the output capacitance on the output of the cell based on placement and routing (e.g., based on capacitances of the wiring and cells the output is connected to) information from step 355. The process also determines the input transition time for an input of the cell based on placement and routing (e.g., based on the circuit driving the input and capacitances of the wiring and cells the input is connected to) information from step 355. Then, for each instantiated cell, the process uses the respective electromigration reliability data table for that cell to determine the maximum toggle rate for the particular input transition time and output capacitance of that cell. Different instances of the same physical cell may have different output capacitances and different input transition times and thus different maximum toggle rates. The process compares the maximum toggle rate for each instantiated cell to a desired operating frequency. The desired operating frequency may also be different for different cells. A reliability issue is indicated when the desired operating frequency is greater than the maximum toggle rate. In an embodiment, the process evaluates a subset of the instantiated cells for susceptibility to electromigration. For example, the process may only evaluate clock buffer cells, which have a high toggle rate.

In step 359, the process determines whether to modify the design based on the electromigration reliability evaluation of step 357. Modifying the design may occur when the electromigration reliability evaluation in step 357 indicates a reliability issue. The design may be modified, for example, by adding buffer cells to reduce output capacitance on a physical cell that has an electromigration reliability issue. If the design will be modified, the process returns to the synthesis step 353. Alternatively, the process may return to the place and route step 355 or the RTL coding step 351.

If the design will not be modified (or re-modified after a previous modification), integrated circuits are fabricated (step 380) from the design produced in the preceding steps. Fabrication of the integrated circuits may be performed, for example, in a semiconductor foundry using a CMOS process.

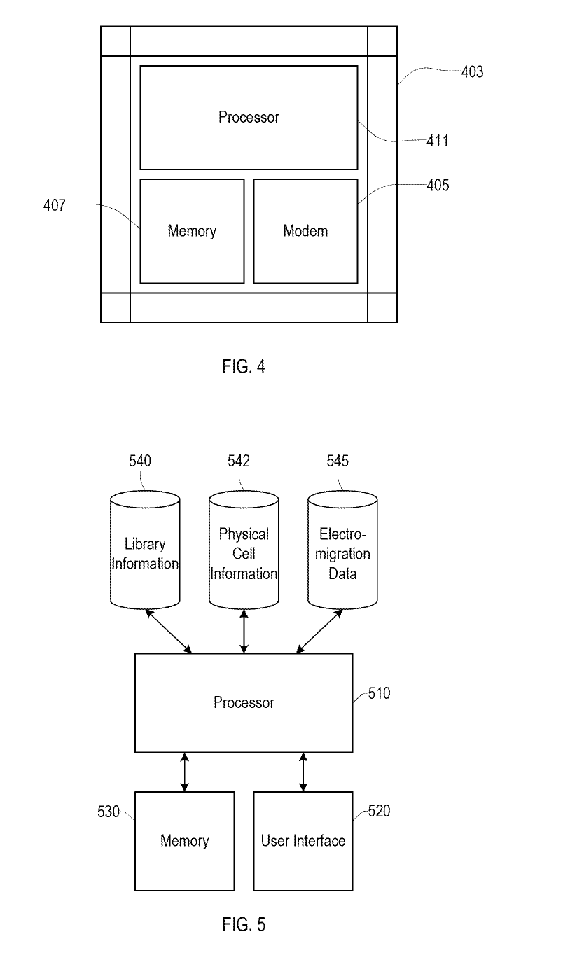

FIG. 4 is a block diagram of an integrated circuit according to a presently disclosed embodiment. The integrated circuit may be created using the process of FIG. 3, which uses electromigration reliability data created using the process of FIG. 1.

The integrated circuit of FIG. 4 includes a processor block 411, a memory block 407, and a modem block 405. Interface blocks 403 about the periphery of the integrated circuit provide communication between blocks of the integrated circuit and other components. In other embodiments, blocks of the integrated circuit may be added to, deleted from, or substituted for the blocks illustrated in the example integrated circuit of FIG. 4.

FIG. 5 is block diagram of a system for generating electromigration reliability data for a library of physical cells according to a presently disclosed embodiment. The system may, for example, generate electromigration reliability data using the process of FIG. 1. The system of FIG. 5 includes a processor 510 and a memory 530. The memory 530 can store data for use by the processor 510. The memory 530 may also store computer readable instructions for execution by the processor 510. The computer readable instructions can be used by the system for generating electromigration reliability data. In an embodiment, the memory 530 or parts of the memory 530 may be considered a non-transitory computer or machine readable medium. The system also includes a user interface 520 (e.g., a display terminal) for a user to receive results from the system and provide inputs to the system.

The system also includes a library information store 540, a physical cell information store 542, and an electromigration reliability data store 545. The library information store 540, the physical cell information store 542, and the electromigration reliability data store 545 may be computer databases. The databases may be combined or shared. The library information store 540 may be used, for example, in block 120 of the process of FIG. 1. The physical cell information store 542 may be used, for example, in block 122 of the process of FIG. 1. The electromigration reliability data store 545 may be used, for example, in step 150 of the process of FIG. 1.

Those of skill will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular constraints imposed on the overall system. Skilled persons can implement the described functionality in varying ways for each particular application, but such implementation decisions should not be interpreted as causing a departure from the scope of the invention. In addition, the grouping of functions within a unit, module, block, or step is for ease of description. Specific functions or steps can be moved from one unit, module or block without departing from the invention.

The various illustrative logical blocks, units, steps and modules described in connection with the embodiments disclosed herein can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter that is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A method for use in generating electromigration reliability data for a physical cell in an integrated circuit cell library, the method comprising:
iteratively evaluating electromigration susceptibility for the physical cell for an input transition time for an input signal of the physical cell and a capacitive loading on an output of the physical cell, wherein each iteration includes:
simulating electrical performance of the physical cell using the input transition time, the capacitive loading, and a data period of the input signal, and
identifying the electromigration susceptibility of the physical cell for the input transition time and the capacitive loading based on current densities from the simulated electrical performance;
determining, after each iteration, whether to perform a further iteration using a comparison of the identified electromigration susceptibility and an evaluation limit;
determining, when it is determined to perform a further iteration, the data period for the further iteration using a relationship between the data period and currents in the physical cell; and
storing, when it is determined to not perform a further iteration, the data period of the last iteration.

2. The method of claim 1, wherein identifying the electromigration susceptibility includes determining a ratio of current density to an electromigration reliability limit for each of multiple regions in the physical cell and identifying the largest of the ratios of current density to electromigration reliability limit.

3. The method of claim 2, wherein determining whether to perform a further iteration includes determining whether the identified electromigration susceptibility is between one and an electromigration accuracy level.

4. The method of claim 1, further comprising determining a minimum data period for operation of the physical cell for the input transition time and the capacitive loading, and wherein determining the data period for the further iteration includes limiting the data period for the further iteration to the minimum data period.

5. The method of claim 4, wherein the minimum data period for operation of the physical cell is a minimum period that results in a full swing of the output of the cell.

6. The method of claim 1, wherein
the electromigration susceptibility is the largest ratio of ratios of average current density to an electromigration reliability limit for each of multiple regions in the physical cell, and
the data period for the further iteration is based on the data period of the prior iteration multiplied by the identified electromigration susceptibility.

7. The method of claim 1, wherein
the electromigration susceptibility is the largest ratio of ratios of root-mean-square (RMS) current density to an electromigration reliability limit for each of multiple regions in the physical cell, and
the data period for the further iteration is based on the data period of the prior iteration multiplied by the square of the electromigration susceptibility.

8. The method of claim 1, wherein
the electromigration susceptibility is the largest ratio of ratios of peak current density to an electromigration reliability limit for each of multiple regions in the physical cell, and
the data period for the further iteration is based on the data period of the prior iteration multiplied by the square of the identified electromigration susceptibility.

9. A method for use in designing an integrated circuit, the method comprising:
evaluating a plurality of cells instantiated in an integrated circuit design to determine whether each of the plurality of cells is susceptible to electromigration, wherein the evaluating includes:
determining an output capacitance on an output of each of the plurality of cells;
determining an input transition time on an input of each of the plurality of cells;
determining, for each of the plurality of cells, a maximum toggle rate using the input transition time and output capacitance for that cell; and
comparing the maximum toggle rate for each of the plurality of cells to a desired operating frequency for that cell.

10. The method of claim 9, further comprising modifying the integrated circuit design when, for at least one of the plurality of cells, the maximum toggle rate for the at least one of the plurality of cells is less than the desired operating frequency for the at least one of the plurality of cells.

11. The method of claim 9, wherein determining, for each of the plurality of cells, a maximum toggle rate using the input transition time and output capacitance for that cell includes using a respective electromigration reliability data table for that cell.

12. The method of claim 9, wherein determining the output capacitance on the output of each of the plurality of cells is based on placement and routing information.

13. The method of claim 9, wherein determining the input transition time on the input of each of the plurality of cells is based on placement and routing information.

14. A method for use in designing an integrated circuit using an integrated circuit cell library, the method comprising:
generating electromigration reliability data for each of a plurality of physical cells in the integrated circuit cell library; and
evaluating electromigration reliability of an integrated circuit design using the generated electromigration reliability data,
wherein generating electromigration reliability data for each of the plurality of physical cells includes generating electromigration reliability data for a plurality of capacitive loadings for each of a plurality of input transition times, wherein for each of the plurality of physical cells, each of the plurality of capacitive loadings, and each of the plurality of input transition times generating the electromigration reliability data includes:
iteratively evaluating electromigration susceptibility for the physical cell for the input transition time for an input signal of the physical cell and the capacitive loading on an output of the physical cell, wherein each iteration includes
simulating electrical performance of the physical cell using the input transition time, the capacitive loading, and a data period of the input signal, and
identifying the electromigration susceptibility of the physical cell for the input transition time and the capacitive loading based on current densities from the simulated electrical performance;
determining, after each iteration, whether to perform a further iteration using a comparison of the identified electromigration susceptibility and an iteration limit;
determining, when it is determined to perform a further iteration, the data period for the further iteration using a relationship between the data period and currents in the physical cell; and
storing, when it is determined to not perform a further iteration, the data period of the last iteration in the electromigration reliability data.

15. The method of claim 14, wherein identifying the electromigration susceptibility includes determining a ratio of current density to an electromigration reliability limit for each of multiple regions in the physical cell and identifying the largest of the ratios of current density to electromigration reliability limit.

16. The method of claim 14, wherein each iteration further includes determining a minimum data period for operation of the physical cell for the input transition time and the capacitive loading, and wherein determining the data period for the further iteration includes limiting the data period for the further iteration to the minimum data period.

17. The method of claim 14, wherein the electromigration reliability data includes data based on average currents, data based on root-mean-square (RMS) currents, and data based on peak currents.

18. The method of claim 14, further comprising modifying the integrated circuit design based on the evaluated electromigration reliability.

19. The method of claim 18, further comprising fabricating the integrated circuit based on the modified integrated circuit design.

20. A non-transitory computer readable medium comprising instructions that, when executed by a processor, cause the processor to perform operations for use in generating electromigration reliability data for a physical cell in an integrated circuit cell library, the instructions comprising instructions that cause the processor to:
iteratively evaluate electromigration susceptibility for the physical cell for an input transition time for an input signal of the physical cell and a capacitive loading on an output of the physical cell, wherein each iteration includes
simulating electrical performance of the physical cell using the input transition time, the capacitive loading, and a data period of transitions on the input signal, and
identifying the electromigration susceptibility of the physical cell for the input transition time and the capacitive loading based on current densities from the simulated electrical performance;
determine, after each iteration, whether to perform a further iteration using a comparison of the identified electromigration susceptibility and an evaluation limit;
determine, when it is determined to perform a further iteration, the data period for the further iteration using a relationship between the data period and currents in the physical cell; and
store, when it is determined to not perform a further iteration, the data period of the last iteration.

21. The non-transitory computer readable medium of claim 20, wherein instructions that cause the processor to identify the electromigration sensitivity include instructions that cause the processor to determine a ratio of current density to an electromigration reliability limit for each of multiple regions in the physical cell and identify the largest of the ratios of current density to electromigration reliability limit.

22. The non-transitory computer readable medium of claim 21, wherein the instructions that cause the processor to determine whether to perform a further iteration include instructions that cause the processor to determine whether the identified electromigration susceptibility is between one and an electromigration accuracy level.

23. The non-transitory computer readable medium of claim 20, further comprising instructions that cause the processor to determine a minimum data period for operation of the physical cell for the input transition time and the capacitive loading, and to limit the data period for the further iteration to the minimum data period.

24. The non-transitory computer readable medium of claim 23, wherein the minimum data period for operation of the physical cell is a minimum period that results in a full swing of the output of the cell.

25. The non-transitory computer readable medium of claim 20, wherein
the electromigration susceptibility is the largest ratio of ratios of average current density to an electromigration reliability limit for each of multiple regions in the physical cell, and
the data period for the further iteration is based on the data period of the prior iteration multiplied by the identified electromigration susceptibility.

26. The non-transitory computer readable medium of claim 20, wherein
the electromigration susceptibility is the largest ratio of ratios of root-mean-square (RMS) current density to an electromigration reliability limit for each of multiple regions in the physical cell, and
the data period for the further iteration is based on the data period of the prior iteration multiplied by the square of the identified electromigration susceptibility.

27. The non-transitory computer readable medium of claim 20, wherein
the electromigration susceptibility is the largest ratio of ratios of peak current density to an electromigration reliability limit for each of multiple regions in the physical cell, and
the data period for the further iteration is based on the data period of the prior iteration multiplied by the square of the identified electromigration susceptibility.

28. The non-transitory computer readable medium of claim 20, further comprising instructions that cause the processor to iteratively evaluate electromigration susceptibility and store the data period of the last iteration for a plurality of capacitive loadings for each of a plurality of input transition times.

29. The non-transitory computer readable medium of claim 20, further comprising instructions that cause the processor to
iteratively evaluate electromigration susceptibility and store the data period of the last iteration, wherein the electromigration sensitivity is based on average currents;
iteratively evaluate electromigration susceptibility and store the data period of the last iteration, wherein the electromigration sensitivity is based on root-mean-square (RMS) currents; and
iteratively evaluate electromigration susceptibility and store the data period of the last iteration, wherein the electromigration sensitivity is based on peak currents.
